(19) United States
(12) Patent Application Publication
(10) Pub. No.: US 2026/0245130 A1
(43) Pub. Date: Aug. 20, 2026

(54) RECOMMENDATION SYSTEM

(71) Applicant: NTT DOCOMO, INC., Tokyo (JP)

(72) Inventors: Yuki KATSUMATA, Tokyo (JP); Yukiko YOSHIKAWA, Tokyo (JP)

(73) Assignee: NTT DOCOMO, INC., Tokyo (JP)

(21) Appl. No.: 19/160,666

(22) PCT Filed: Mar. 5, 2024
(86) PCT No.: PCT/JP2024/008316

§ 371 Date: Aug. 28, 2025

(30) Foreign Application Priority Data
May 19, 2023 (JP) 2023-083045

(51) Int. Cl. G06Q 30/0601

(52) U.S. Cl. CPC G06Q 30/0631

(57) ABSTRACT

A recommendation system includes: a first determination unit configured to determine a predetermined number of recommendation formats from a plurality of recommendation formats in descending order of predicted behavioral change effectiveness for a user; a recommendation generation unit configured to generate a predetermined number of recommendation contents corresponding to the predetermined number of recommendation formats determined by the first determination unit; and a second determination unit configured to output, from the predetermined number of recommendation contents generated by the recommendation generation unit, the recommendation content predicted to have the highest behavioral change effectiveness for the user.

### TECHNICAL FIELD

The present disclosure relates to a recommendation system.

### BACKGROUND ART

Patent Literature 1 discloses a recommendation system that corrects biases in user behavior by prompting actions through the spontaneously selection of latent preferences by the user. In this recommendation system, the content of the recommendation is determined based on the selected nudge.

### CITATION LIST

### Patent Literature

[Patent Literature 1] Japanese Unexamined Patent Publication No. 2022-129411

### SUMMARY OF INVENTION

### Technical Problem

A recommendation system that outputs recommendation content to a service system is known. When the service system has multiple output formats, even recommendations based on the same nudge may vary in content depending on the output format. For example, even if a nudge suitable for a user is selected, the output recommendation content may not be appropriate for the user.

An embodiment of the present invention was contrived in view of such circumstances, and an object thereof is to provide a recommendation system capable of efficiently outputting recommendation content suitable for a user.

### Solution to Problem

A recommendation system according to the present disclosure includes: a first determination unit configured to determine a predetermined number of recommendation formats from a plurality of recommendation formats in descending order of predicted behavioral change effectiveness for a user as an output format of data; a recommendation generation unit configured to generate a predetermined number of recommendation contents corresponding to the predetermined number of recommendation formats determined by the first determination unit; and a second determination unit configured to output, from the predetermined number of recommendation contents generated by the recommendation generation unit, the recommendation content predicted to have the highest behavioral change effectiveness for the user.

In the above recommendation system, the first determination unit estimates a predetermined number of recommendation formats that are effective for the user, and the recommendation generation unit generates recommendation content for each of the predetermined number of recommendation formats. The second determination unit then outputs the recommendation content most suitable for the user from the generated recommendation contents. Thus, by undergoing a first stage in which a predetermined number of recommendation formats are determined based on behavioral change effectiveness and a second stage in which the recommendation content to be output is selected from the predetermined number of recommendation contents generated based on the first stage, recommendation content with high behavioral change effectiveness can be efficiently output.

### Advantageous Effects of Invention

According to the present disclosure, a recommendation system capable of efficiently outputting recommendation content suitable for a user can be provided.

### BRIEF DESCRIPTION OF DRAWINGS

FIG. 1 is a diagram illustrating the configuration of a recommendation system according to an embodiment of the present disclosure.

FIG. 2 is a diagram illustrating an example of data input to an information reception unit.

FIG. 3 is a diagram illustrating an example of the content of a recommendation execution history.

FIG. 4 is a diagram illustrating an example of the content of a weight database.

FIG. 5 is a diagram illustrating an example of the content of a system database.

FIG. 6 is a diagram illustrating an example of the content of a recommendation format database.

FIG. 7 is a diagram illustrating an example of data of a recommendation generated by a generation unit.

FIG. 8 is a diagram illustrating an example of a recommendation content database.

FIG. 9 is a flowchart illustrating an example of the operation of the recommendation system.

FIG. 10 is a diagram illustrating the hardware configuration of the recommendation system according to an embodiment of the present disclosure.

### DESCRIPTION OF EMBODIMENTS

Hereinafter, embodiments of the recommendation system according to the present disclosure will be described in detail with reference to the drawings. In the description of the drawings, identical elements are denoted by identical reference numerals, and redundant descriptions are omitted.

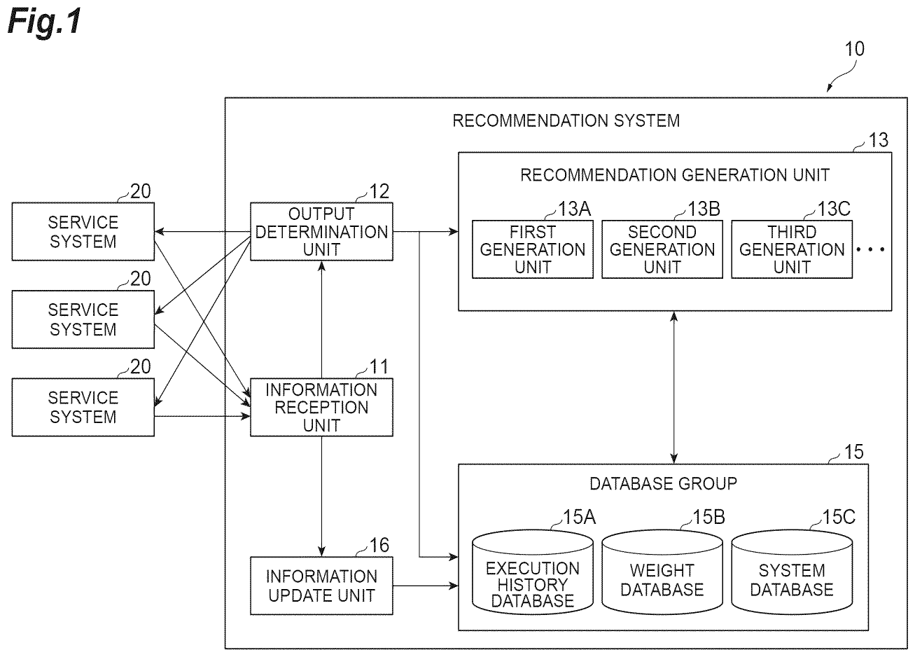

FIG. 1 illustrates a recommendation system 10 according to the present embodiment. The recommendation system 10 is a system (apparatus) configured to determine recommendation content for prompting a predetermined action for a target user in a service provided to a plurality of users including the target user. The service provided to the user is, for example, operated via a mobile communication network. As an example, the service may be a service provided to the user in a virtual space (e.g., a so-called metaverse) constructed on a computer network. The service may be provided, for example, by an external service system 20 (counterpart system) different from the recommendation system 10. The recommendation system 10 is configured to enable transmission and reception of data with the service system 20 via a communication network. The plurality of service systems 20 shown in FIG. 1 may be systems that provide different services to users.

The service system 20 that provides a service to a user, for example, transmits a recommendation request for the user to the recommendation system 10 at a predetermined timing when the user is logged into the service. Upon receiving the recommendation request for the user from the service system 20, the recommendation system 10 outputs the generated recommendation to the service system 20. For example, the service system 20 may transmit the recommendation request to the recommendation system 10 at the timing when the user logs into the service. Alternatively, the service system 20 may transmit the recommendation request to the recommendation system 10 based on the current time, current location, or the like. The recommendation request may be data including at least identification information for identifying the user.

The recommendation content for a user is generated based on information including a recommendation format and a nudge type. The recommendation format refers to the type of output format for recommendations in the service system 20. The service system 20 according to the present embodiment is capable of outputting recommendations to the user based on a plurality of output formats. For example, the recommendation format may include text output that conveys a recommendation by displaying text, audio output that conveys a recommendation through sound, or object output that conveys a recommendation by causing a predetermined object to appear, or the like, on a display device.

The recommendation for a user is performed, for example, by transmitting data corresponding to the recommendation content from the recommendation system 10 to the user's terminal via the service system 20. An output corresponding to the recommendation content is performed at the terminal, allowing the user to recognize the recommendation.

The terminal is a device capable of transmitting and receiving information with the service system 20 via a network, such as a mobile communication network, and performing information processing related to recommendations. The terminal may be a device such as a mobile phone, smartphone, or personal computer (PC). The transmission and reception of information related to recommendations with the recommendation system 10, as well as the input and output of such information at the terminal, may be performed by a dedicated application installed on the terminal. Some of the information used by the recommendation system 10 may be acquired by the terminal and transmitted to the recommendation system 10.

A nudge refers to a mechanism or strategy based on cognitive biases designed to prompt a user to spontaneously (unconsciously) select a desirable action. The nudge type may be a classification of nudges based on cognitive biases. For example, nudge types may include “conformity,” where a user unconsciously aligns with the thoughts or actions of others; “loss aversion,” where avoiding loss is prioritized over gaining benefits; or “scarcity,” where value increases due to rarity or difficulty of acquisition.

As shown in FIG. 1, an example of the recommendation system 10 includes an information reception unit 11, an output determination unit 12 (first determination unit and second determination unit), a recommendation generation unit 13, a database group 15, and an information update unit 16. In the recommendation system 10, when a recommendation request is input to the information reception unit 11, the output determination unit 12 determines a predetermined number of recommendation formats. When recommendation content corresponding to the determined recommendation formats is generated by the recommendation generation unit 13, the output determination unit 12 outputs the recommendation with the highest behavioral change effectiveness from the generated recommendation contents to the service system 20. The details of the recommendation system 10 will be described below.

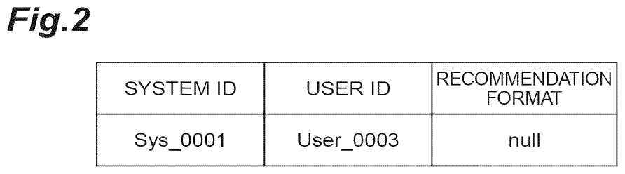

The information reception unit 11 receives various pieces of information necessary for generating recommendations from the service system 20. As an example, the information reception unit 11 receives data related to a recommendation request from the service system 20. FIG. 2 illustrates an example of data related to a recommendation request. The data related to the recommendation request includes at least identification information (user ID) for identifying a user. The data shown in FIG. 2 includes a system ID identifying the service system 20, a user ID identifying the user who is the target of the recommendation, and a recommendation format indicating the output format of the recommendation. In the example of FIG. 2, the recommendation format input from the service system 20 identified as “Sys_0001” is “null,” indicating that no recommendation format has been specified by the service system 20. In other words, the service system 20 does not designate a recommendation format to the recommendation system 10. Therefore, the recommendation system 10 outputs a recommendation with the format most suitable for the user from among the available recommendation formats to the service system 20.

The information reception unit 11 may receive data related to recommendation results from the service system 20. The data related to recommendation results may include information (presence/absence of effect) indicating whether a behavioral change occurred in the user based on the recommendation content output from the recommendation system 10 to the service system 20. As an example, the data related to recommendation results may include a user ID, the time of the recommendation, the recommendation format, the recommendation content, the nudge type, and the presence/absence of effect.

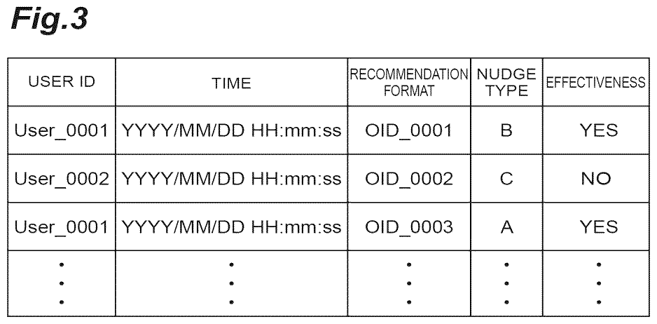

The database group 15 stores various pieces of data necessary for the processing of the output determination unit 12 and the recommendation generation unit 13. As shown in FIG. 1, an example of the database group 15 includes an execution history database 15A, a weight database 15B, and a system database 15C. The execution history database 15A stores recommendation results when recommendations are executed for users. FIG. 3 illustrates an example of the execution history database 15A. An example of the execution history database 15A includes a user ID, the time when the recommendation was executed, the recommendation format, the nudge type of the recommendation, and the presence/absence of effect of the recommendation.

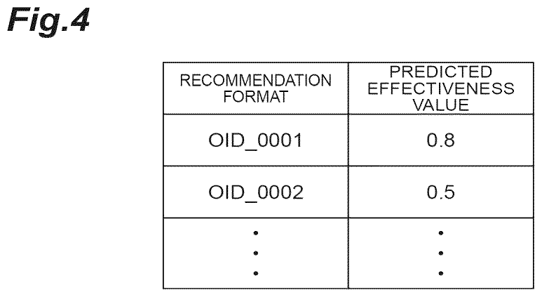

FIG. 4 illustrates an example of the content of the weight database. The weight database 15B stores data indicating predicted effectiveness values for each recommendation format. The predicted effectiveness values in the weight database 15B indicate the behavioral change effectiveness for each recommendation format, generated without identifying a specific user. The predicted effectiveness value is an index indicating the likelihood of a behavioral change occurring in a user when a recommendation is executed. The predicted effectiveness value may be a score value indicating the probability of a behavioral change occurring, or the like. The predicted effectiveness value may be calculated based on the execution history database 15A. For example, the predicted effectiveness value may be calculated based on recommendation results (presence/absence of effect) for the same recommendation format extracted from the execution history database 15A without identifying a specific user.

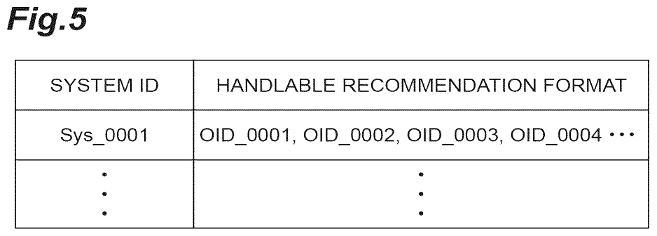

FIG. 5 illustrates an example of the content of the system database. The system database 15C stores the types of recommendation formats that can be handled by each service system 20. For example, as described above, the service system 20 identified as “Sys_0001” does not specify a recommendation format in the recommendation request, but all assumed recommendation formats may be handled by the service system 20.

The database group 15 may include a database storing attribute information indicating attributes of each user. As an example, the user attributes may include information capable of estimating the user's cognitive biases, such as gender, residential area, occupation, family composition, hobbies, and preferences.

The information update unit 16 updates the content of the database group 15. For example, the information update unit 16 updates the content of the execution history database 15A based on the results of recommendations input from the service system 20. Additionally, when the content of the execution history database 15A is updated, the information update unit 16 updates the content of the weight database 15B to reflect the updated content of the execution history database 15A.

The output determination unit 12 has a function as the first determination unit and a function as the second determination unit. First, the output determination unit 12 as the first determination unit will be described, and the output determination unit 12 as the second determination unit will be described after the explanation of the recommendation generation unit 13. The output determination unit 12, as the first determination unit, determines a predetermined number of recommendation formats in descending order of predicted behavioral change effectiveness for the user from a plurality of recommendation formats. For example, the output determination unit 12 determines the predetermined number of recommendation formats based on first information including at least a past recommendation execution history that confirms the behavioral change effectiveness for the user for each of the plurality of recommendation formats. As an example, the first information includes scores indicating the weighting of behavioral change effectiveness for the plurality of recommendation formats that are generated without identifying specific users. The output determination unit 12 determines the predetermined number of recommendation formats based on the score and the user's execution history.

For example, the output determination unit 12 acquires the past execution history of a user who is the target of recommendation generation from the execution history database 15A. In one example, the output determination unit 12 may extract, from the execution history database 15A, the execution history of recommendations corresponding to the target user ID and recommendation format. Additionally, the output determination unit 12 acquires data from the weight database 15B. Then, the output determination unit 12 creates a recommendation format database based on the data (first information) extracted from the execution history database 15A and the data (first information) from the weight database 15B.

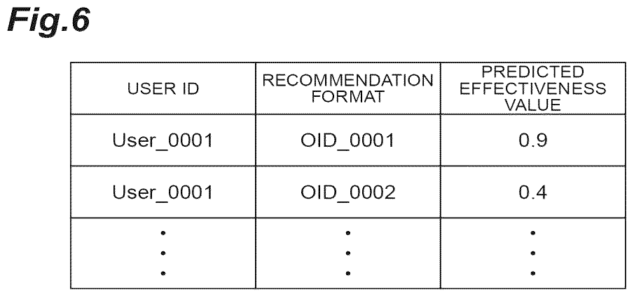

FIG. 6 illustrates an example of the content of the recommendation format database. The recommendation format database stores score values (predicted effectiveness values) that indicate, for each recommendation format, the probability or likelihood of behavioral change in the user. In other words, the recommendation format database stores data indicating the likelihood of a user's behavioral change for each recommendation format.

For example, predicted effectiveness values may be calculated for each recommendation format and for each user using a machine learning method that takes as input the past execution history of recommendations for the user and the weight database 15B. Based on the recommendation format database thus calculated, the output determination unit 12 selects a predetermined number (e.g., three) of recommendation formats in descending order of predicted effectiveness values for the specified user and requests the recommendation generation unit 13 to generate recommendations corresponding to these recommendation formats.

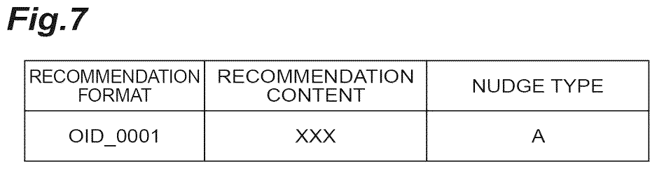

The recommendation generation unit 13 generates a predetermined number of recommendation contents corresponding to the predetermined number of recommendation formats determined by the output determination unit 12 as the first determination unit. FIG. 7 illustrates an example of data of recommendations generated by the recommendation generation unit. The data of recommendations generated by the recommendation generation unit 13 includes, for example, data regarding the recommendation format, recommendation content, and nudge type. The recommendation generation unit 13 outputs the generated recommendation data to the output determination unit 12.

An example of the recommendation generation unit 13 includes a plurality of generation units that generate recommendation contents corresponding to a plurality of recommendation formats. For example, in the illustrated example, a first generation unit 13A generates recommendation content for the recommendation format of “text output,” a second generation unit 13B generates recommendation content for the recommendation format of “audio output,” and a third generation unit 13C generates recommendation content for the recommendation format of “object output.” In the illustrated example, generation units other than the first to third generation units, which correspond to text, audio, and object outputs, respectively, are omitted in the illustration.

As described above, the recommendation content is generated based on information that includes the recommendation format and the nudge type. Accordingly, the recommendation generation unit 13 determines a nudge type suitable for the user based on the cognitive biases of the target user. The recommendation generation unit 13 may have information regarding the user's cognitive biases in advance. Additionally, the recommendation generation unit 13 may estimate the user's cognitive biases. For example, the recommendation generation unit 13 may estimate the user's cognitive biases using an estimation model (e.g., a regression analysis model) based on the user's attributes. In this case, information related to the user's attributes may be pre-stored in the database group 15.

The recommendation generation unit 13 selects a nudge type based on the acquired cognitive biases. The cognitive biases and nudge types may correspond one-to-one. For example, if the estimation model estimates that the user's cognitive bias is conformity bias, the recommendation generation unit 13 selects “conformity” as the nudge type. Similarly, if the user's cognitive biases are estimated to be “loss aversion bias” or “scarcity bias,” the nudge types “loss aversion” or “scarcity” are selected, respectively. Each generation unit corresponding to a recommendation format generates recommendation content based on the selected nudge type.

For example, the case of generating a recommendation to promote the use of a coupon is illustrated. The first generation unit 13A, corresponding to text output, generates text such as “Others are also using it” when the nudge type is “conformity.” When the nudge type is “loss aversion,” the first generation unit 13A generates text such as “It's a waste not to use the coupon.” The text generated by the first generation unit 13A may be selected from a plurality of pre-set texts for each nudge. The first generation unit 13A may, for example, select text suitable for the content of the recommendation. The generated text may be a partial sentence, such as “Others also.” In this case, the service system 20 may complement the generated text with additional text.

The second generation unit 13B, corresponding to audio output, generates audio data for text such as “Others are also using it” when the nudge type is “conformity.” The text constituting the audio data may be generated by the same method as the first generation unit 13A. The second generation unit 13B may, for example, select an audio type based on the content of the recommendation. The audio type may be set according to the speaker, such as “male voice,” “female voice,” or “child's voice,” or may be set more specifically, such as “slow male voice.” Alternatively, the second generation unit 13B may generate only parameters for generating audio data instead of the audio data itself. In this case, the service system 20 may generate audio data based on the generated parameters.

The third generation unit 13C, corresponding to object output, generates an object that integrates, for example, text such as “Others are also using it” with an image representing a coupon when the nudge type is “conformity.” The third generation unit 13C may, for example, select the content of the object based on the content of the recommendation. For example, the text as an object may be selected from text displayed on a signboard, a person's dialogue (speech bubble), or the like. Additionally, the coupon as an object may be selected from a two-dimensional image, a three-dimensional image, or the like.

The output determination unit 12, as the second determination unit, outputs to the service system 20 the recommendation content predicted to have the highest behavioral change effectiveness for the user from among the predetermined number of recommendation contents generated by the recommendation generation unit 13. For example, the output determination unit 12 outputs the recommendation content predicted to have the highest behavioral change effectiveness for the user based on second information including at least a past recommendation execution history that confirms the behavioral change effectiveness for each nudge type of the recommendation content for the user. In one example, the second information includes scores indicating the weighting of behavioral change effectiveness for a plurality of recommendation formats that are generated without identifying specific users, and the output determination unit 12 outputs the recommendation content predicted to have the highest behavioral change effectiveness for the user based on the score and the user's execution history.

For example, the output determination unit 12 acquires the past execution history of recommendations for the user who is the target of recommendation output from the execution history database 15A. Specifically, the output determination unit 12 extracts the execution history of recommendations for the target user ID from the execution history database 15A. Additionally, the output determination unit 12 acquires data from the weight database 15B. Then, the output determination unit 12 creates a recommendation content database based on the data extracted from the execution history database 15A (second information) and the data from the weight database 15B (second information).

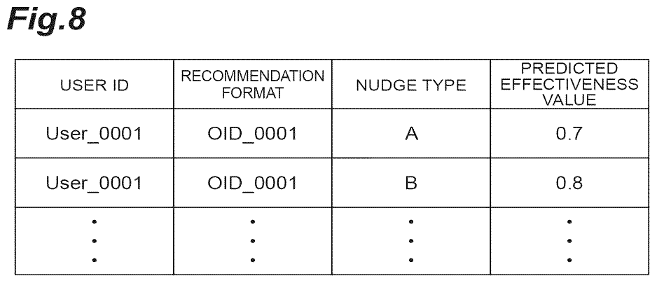

FIG. 8 illustrates an example of the content of the recommendation content database. The recommendation content database stores predicted effectiveness values indicating the probability of a behavioral change for the target user when receiving a recommendation with a specific nudge type in a specific recommendation format. In other words, the recommendation content database stores data indicating the likelihood of a behavioral change for the target user for recommendations corresponding to each nudge type in each recommendation format.

For example, predicted effectiveness values may be calculated for each nudge type in each recommendation format and for each user using a machine learning method that takes as input the past execution history of recommendations for the user and the weight database 15B. Based on the recommendation content database thus calculated, the output determination unit 12 selects the recommendation content with the highest predicted effectiveness value for the specified user and outputs the selected recommendation content to the service system 20.

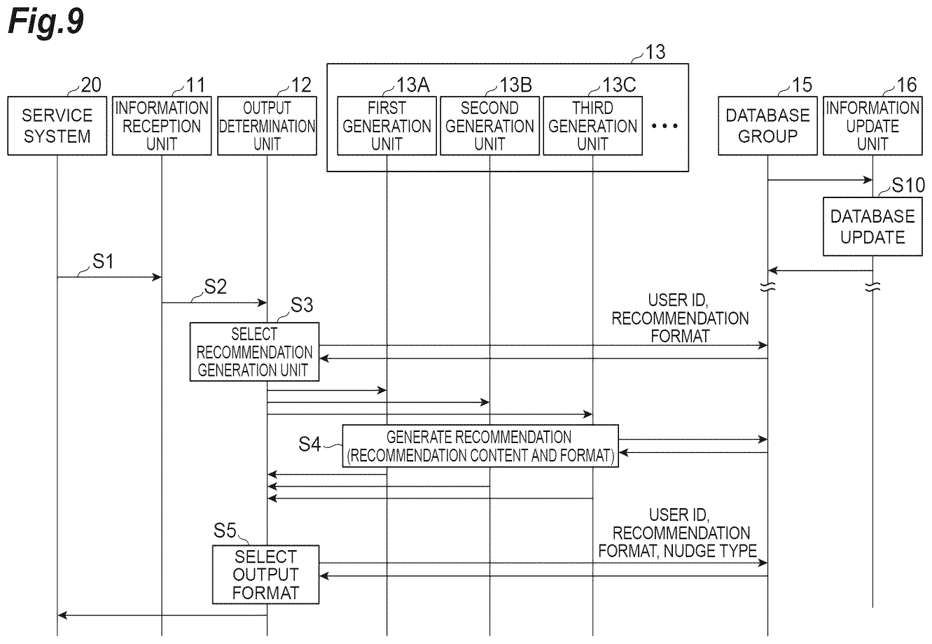

FIG. 9 is a flowchart illustrating the operation of the recommendation system 10. As shown in FIG. 9, when recommendation generation is executed in the recommendation system 10, first, a recommendation request is output from the service system 20 to the information reception unit 11 (step S1), and the output determination unit 12 receives the recommendation request (step S2). Subsequently, the output determination unit 12 selects a generation unit for executing recommendation generation (step S3). Specifically, the output determination unit 12 extracts the execution history of recommendations corresponding to the user ID and recommendation format from the execution history database 15A. The database group 15, including the execution history database 15A, is periodically updated by the information update unit 16 (step S10). The output determination unit 12 generates a recommendation format database based on the extracted data and determines a predetermined number of recommendation formats based on the generated recommendation format database. The output determination unit 12 requests the generation of recommendation content from the generation units corresponding to the determined predetermined number of recommendation formats. Subsequently, recommendations are generated by the selected generation units (in the example of FIG. 9, the first generation unit 13A, second generation unit 13B, and third generation unit 13C) (step S4). Each generation unit outputs the generated recommendations to the output determination unit 12. The output recommendations may be data in which the recommendation format, recommendation content, and nudge type are associated with each other. Subsequently, the output determination unit 12 selects the recommendation to be output to the service system 20 from among the generated predetermined number of recommendations (step S5). Specifically, the output determination unit 12 extracts the past execution history of recommendations corresponding to the user ID, recommendation format, and nudge type for the recommendations generated by the recommendation generation unit from the execution history database 15A. Then, the output determination unit 12 generates a recommendation content database based on the extracted data and the weight database and determines the output format of the recommendation predicted to have the highest behavioral change effectiveness for the user based on the generated recommendation content database. The output determination unit 12 outputs the determined recommendation content to the service system 20. As a result, the service system 20 can cause the target user's terminal to output the recommendation. The result of the recommendation (e.g., information on whether the coupon was used) is transmitted from the service system 20 to the information reception unit 11 and can be used by the information update unit 16 to update the database group 15.

As described above, an example of the recommendation system 10 includes: a first determination unit (output determination unit 12) configured to determine a predetermined number of recommendation formats from a plurality of recommendation formats in descending order of predicted behavioral change effectiveness for a user as the output format of data; a recommendation generation unit 13 configured to generate a predetermined number of recommendation contents corresponding to the predetermined number of recommendation formats determined by the first determination unit; and a second determination unit (output determination unit 12) configured to output, from the predetermined number of recommendation contents generated by the recommendation generation unit 13, the recommendation content predicted to have the highest behavioral change effectiveness for the user.

In the above recommendation system 10, the first determination unit estimates a predetermined number of recommendation formats that are effective for the user, and the recommendation generation unit 13 generates recommendation content for each of the predetermined number of recommendation formats. The second determination unit then outputs the recommendation content most suitable for the user from the generated recommendation contents. Thus, in the recommendation system 10 according to the present embodiment, recommendations are determined through a first stage in which a predetermined number of recommendation formats are determined based on behavioral change effectiveness and a second stage in which the recommendation content to be output is selected from the predetermined number of recommendation contents generated based on the first stage, thereby enabling efficient output of recommendation content with high behavioral change effectiveness.

The first determination unit may determine the predetermined number of recommendation formats based on first information including at least a past recommendation execution history that confirms the behavioral change effectiveness for each of the plurality of recommendation formats for the user. In this configuration, since the first information includes the user's past execution history, recommendation formats suitable for each user can be efficiently estimated.

The first information may include scores indicating the weighting of behavioral change effectiveness for the plurality of recommendation formats that are generated without identifying specific users, and the first determination unit may determine the predetermined number of recommendation formats based on the score and the user's execution history. In this configuration, since the first determination unit estimates recommendation formats based not only on the user's execution history but also on scores not identifying a specific user, bias in the estimation results can be suppressed.

The second determination unit may output the recommendation content predicted to have the highest behavioral change effectiveness for the user based on second information including at least a past recommendation execution history that confirms the behavioral change effectiveness for each nudge type of the recommendation content for the user. In this configuration, since the second information includes the user's past execution history, recommendation content suitable for each user can be appropriately selected.

The second information may include scores indicating the weighting of behavioral change effectiveness for the plurality of recommendation formats that are generated without identifying specific users, and the second determination unit may output the recommendation content predicted to have the highest behavioral change effectiveness for the user based on the score and the user's execution history. In this configuration, since the second determination unit determines recommendation content based not only on the user's execution history but also on scores not identifying a specific user, bias in the determination results can be suppressed.

In the above embodiment, an example has been described in which all recommendation formats that can be generated by the recommendation system 10 are supported by the service system 20. However, in one example of the recommendation system 10, recommendations can also be output to a service system capable of supporting only specific recommendation formats. For example, when a service system supports only some recommendation formats, the service system may transmit data specifying the types of supported recommendation formats to the recommendation system 10 when requesting a recommendation from the recommendation system 10. In this case, the recommendation system 10 can select the recommendation most suitable for the user from among the specified recommendation formats. If the types of recommendation formats are not specified, the output determination unit 12 may access the system database 15C to acquire the types of recommendation formats supported by the service system.

Additionally, while a service system providing services to users in a virtual space constructed on a computer network has been described, the services provided by the service system are not limited to the above.

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining software into the apparatus described above or the plurality of apparatuses described above.

Functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

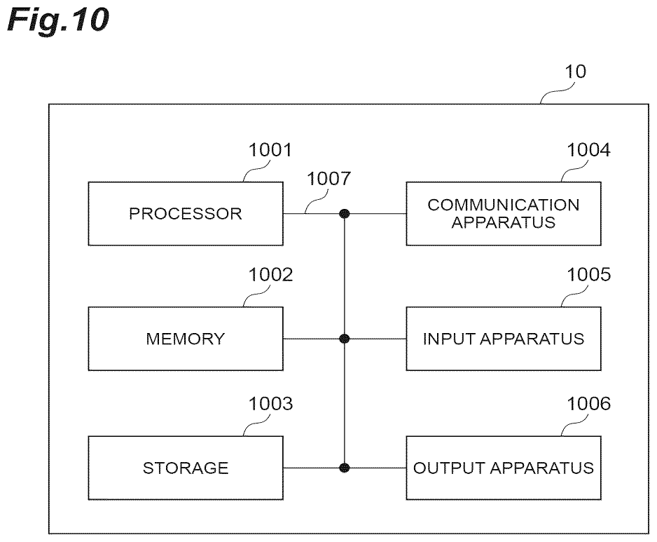

For example, recommendation system 10 according to one embodiment of the present disclosure may function as a computer that executes the information processing of the present disclosure. FIG. 10 is a diagram to show an example of a hardware structure of recommendation system 10 according to one embodiment. Physically, the above-described recommendation system 10 may each be formed as a computer apparatus that includes a processor 1001, a memory 1002, a storage 1003, a communication apparatus 1004, an input apparatus 1005, an output apparatus 1006, a bus 1007, and so on. The hardware configuration of the service system 20 may also be described herein.

Note that in the present disclosure, the words such as an apparatus, a circuit, a device, a section, a unit, and so on can be interchangeably interpreted. The hardware structure of recommendation system 10 may be configured to include one or more of apparatuses shown in the drawings, or may be configured not to include part of apparatuses.

Each function of recommendation system 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described recommendation system 10, and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, each function of recommendation system 10 may be implemented by control programs that are stored in the memory 1002 and that operate on the processor 1001, and other functional blocks may be implemented likewise. The various processes have been described to be performed by a single processor 1001. However, the processes may be performed by two or more processors 1001 simultaneously or sequentially. The processor 1001 may be implemented by one or more chips. It should be noted that the program may be transmitted from a network via a telecommunication line.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “auxiliary storage apparatus.” Recording medium provided in recommendation system 10 may be a database including the memory 1002 and/or the storage 1003, a server, or any other appropriate medium.

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the recommendation system 10 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The input or output information may be stored in a specific location (e.g., memory) or managed using management tables. The input or output information may be overwritten, updated, or added. The information that has been output may be deleted. The information that has been input may be transmitted to another apparatus.

A decision or a determination in an embodiment of the present invention may be realized by a value (0 or 1) represented by one bit, by a boolean value (true or false), or by comparison of numerical values (e.g., comparison with a predetermined value).

Each aspect/embodiment described in the present specification may be used independently, may be used in combination, or may be used by switching according to operations. Further, notification (transmission/reporting) of predetermined information (e.g., notification (transmission/reporting) of “X”) is not limited to an explicit notification (transmission/reporting), and may be performed by an implicit notification (transmission/reporting) (e.g., by not performing notification (transmission/reporting) of the predetermined information).

As described above, the present invention has been described in detail. It is apparent to a person skilled in the art that the present invention is not limited to one or more embodiments of the present invention described in the present specification. Modifications, alternatives, replacements, etc., of the present invention may be possible without departing from the subject matter and the scope of the present invention defined by the descriptions of claims. Therefore, the descriptions of the present specification are for illustrative purposes only, and are not intended to be limitations to the present invention.

Software should be broadly interpreted to mean, whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL), etc.) or wireless technologies (infrared, microwave, etc.), at least one of these wired line technologies or wireless technologies is included within the definition of the transmission medium.

As used in the present disclosure, the terms “system” and “network” are used interchangeably.

Further, the information, parameters, and the like, described in the present disclosure may be expressed using absolute values, relative values from predetermined values, or they may be expressed using corresponding different information.

As used herein, the term “determining” may encompasses a wide variety of actions. For example, “determining” may be regarded as judging, calculating, computing, processing, deriving, investigating, looking up (e.g., looking up in a table, a database or another data structure), ascertaining and the like. Also, “determining” may be regarded as receiving (e.g., receiving information), transmitting (e.g., transmitting information), inputting, outputting, accessing (e.g., accessing data in a memory) and the like. Also, “determining” may be regarded as resolving, selecting, choosing, establishing and the like. That is, “determining” may be regarded as a certain type of action related to determining.

The term “connected” or “coupled” or any variation thereof means any direct or indirect connection or connection between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of the one or more wires, cables, or printed electrical connections and, as a number of non-limiting and non-inclusive examples, electromagnetic energy having wavelengths in the radio frequency region, the microwave region, and the light (both visible and invisible) region.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

In the case where the terms “include”, “including” and variations thereof are used in the present disclosure, these terms are intended to be comprehensive in the same way as the term “comprising”. Further, the term “or” used in the present specification is not intended to be an “exclusive or”.

In the present disclosure, where an article is added by translation, for example “a”, “an”, and “the”, the disclosure may include that the noun following these articles is plural.

In this disclosure, the term “A and B are different” may mean “A and B are different from each other.” It should be noted that the term “A and B are different” may mean “A and B are different from C.” Terms such as “separated” or “combined” may be interpreted in the same way as the above-described “different”.

### REFERENCE SIGNS LIST

10 Recommendation system, 11 Information reception unit, 12 Output determination unit, 13 Recommendation generation unit, 15 Database group, 16 Information update unit, 20 Service system, 1001 Processor, 1002 Memory, 1003 Storage, 1004 Communication apparatus, 1005 Input apparatus, 1006 Output apparatus, 1007 Bus

1. A recommendation system comprising:
a first determination unit configured to determine a predetermined number of recommendation formats from a plurality of recommendation formats in descending order of predicted behavioral change effectiveness for a user as an output format of data;
a recommendation generation unit configured to generate a predetermined number of recommendation contents corresponding to the predetermined number of recommendation formats determined by the first determination unit; and
a second determination unit configured to determine, from the predetermined number of recommendation contents generated by the recommendation generation unit, the recommendation content predicted to have the highest behavioral change effectiveness for the user.

2. The recommendation system according to claim 1, wherein the first determination unit determines the predetermined number of recommendation formats based on first information including at least a past recommendation execution history that confirms the behavioral change effectiveness for each of the plurality of recommendation formats for the user.

3. The recommendation system according to claim 2, wherein the first information includes scores indicating a weighting of the behavioral change effectiveness for the plurality of recommendation formats that are generated without identifying specific users, and
the first determination unit determines the predetermined number of recommendation formats based on the score and the execution history of the user.

4. The recommendation system according to claim 1, wherein the second determination unit determines the recommendation content predicted to have the highest behavioral change effectiveness for the user based on second information including at least a past recommendation execution history that confirms the behavioral change effectiveness for each nudge type of the recommendation content for the user.

5. The recommendation system according to claim 4, wherein the second information includes scores indicating a weighting of the behavioral change effectiveness for the plurality of recommendation formats that are generated without identifying specific users, and
the second determination unit determines the recommendation content predicted to have the highest behavioral change effectiveness for the user based on the score and the execution history of the user.
